(19) United States
(12) Patent Application Publication
(10) Pub. No.: US 2022/0154004 A1
(43) Pub. Date: May 19, 2022

(54) CONVERTING PLASTIC WASTE INTO CARBON PIGMENT

(71) Applicant: IsraZion Ltd., Kfar Yehoshua (IL)

(72) Inventor: David JACOB, Kfar Yehoshua (IL)

(73) Assignee: IsraZion Ltd., Kfar Yehoshua (IL)

(21) Appl. No.: 16/950,316

(22) Filed: Nov. 17, 2020

(51) Int. Cl. C09C 1/48; C09C 1/54

(52) U.S. Cl. CPC C09C 1/482; C09C 1/54; C01P 2002/85; C01P 2004/03; C01P 2004/04; C01P 2004/64

(57) ABSTRACT

Systems and methods are provided for converting plastic waste into carbon pigment. Received polymer material such as plastic waste is degraded at 350-600° C. to form carbon-rich liquid and non-condensable syngas, and the carbon-rich liquid is then pyrolyzed at 1100-2200° C. to form carbon nanoparticles that may be used as carbon pigment. The syngas and possibly some of the form carbon-rich liquid may be used to provide heat to the system.

### BACKGROUND OF THE INVENTION

### 1. Technical Field

The present invention relates to the field of plastic waste treatment, and more particularly, to producing carbon pigment from plastic waste.

### 2. Discussion of Related Art

Plastic waste, typically made of carbon-based polymers, is produced in large amounts that cause disposal challenges and/or environmental pollution.

U.S. Pat. Nos. 9,181,134 and 10,000,385, incorporated herein by reference in their entirety, teach processes of converting textile solid waste and/or plastic waste materials into graphite, carbon fibers and/or activated carbon.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a method of converting plastic waste into carbon pigment, the method comprising: degrading received polymer material at 350-600° C. to form carbon-rich liquid and non-condensable syngas, and pyrolyzing the carbon-rich liquid at 1100-2200° C. to form carbon nanoparticles.

One aspect of the present invention provides a system for converting plastic waste into carbon pigment, the system comprising: a degradation chamber configured to degrade received polymer material at 350-600° C. to form carbon-rich liquid and non-condensable syngas, and a pyrolysis chamber configured to pyrolyze at least part of the carbon-rich liquid received from the degradation chamber at 1100-2200° C. to form carbon nanoparticles.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 1-3 are high-level schematic illustrations of systems and methods of converting plastic waste into carbon pigment, according to some embodiments of the invention.

FIG. 4 illustrates schematically white and black plastic waste used as raw material, according to some embodiments of the invention.

FIG. 5 illustrates schematically HRSEM (high-resolution scanning electron microscopy) and HRTEM (high-resolution transmission electron microscopy) images of carbon black nanoparticles produced from plastic waste, according to some embodiments of the invention.

FIG. 6 illustrates schematically an EDX (energy-dispersive X-ray spectroscopy) diagram of the carbon black nanoparticles produces from the plastic waste, having 98% elemental carbon content, according to some embodiments of the invention.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Embodiments of the present invention provide efficient and economical methods and mechanisms for processing of waste plastic into carbon pigment and thereby provide improvements to the technological field of plastic waste reduction as well as carbon production. Systems and methods are provided for converting plastic waste into carbon pigment. Received polymer material such as plastic waste is degraded at 350-600° C. to form carbon-rich liquid and non-condensable syngas, and the carbon-rich liquid is then pyrolyzed at 1100-2200° C. to form carbon nanoparticles that may be used as carbon pigment. The syngas and possibly some of the form carbon-rich liquid may be used to provide heat to the system.

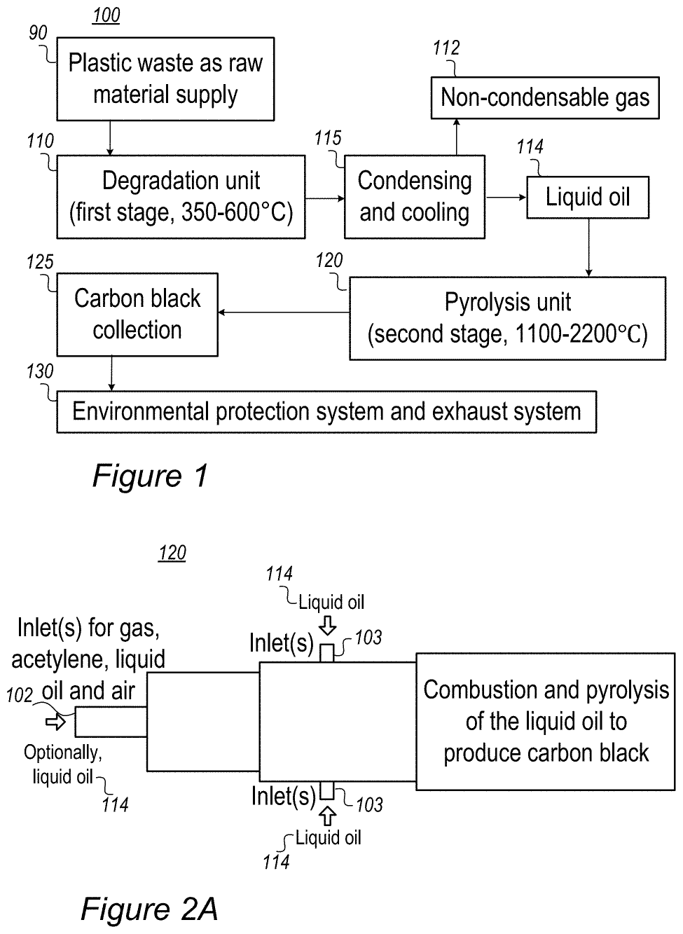

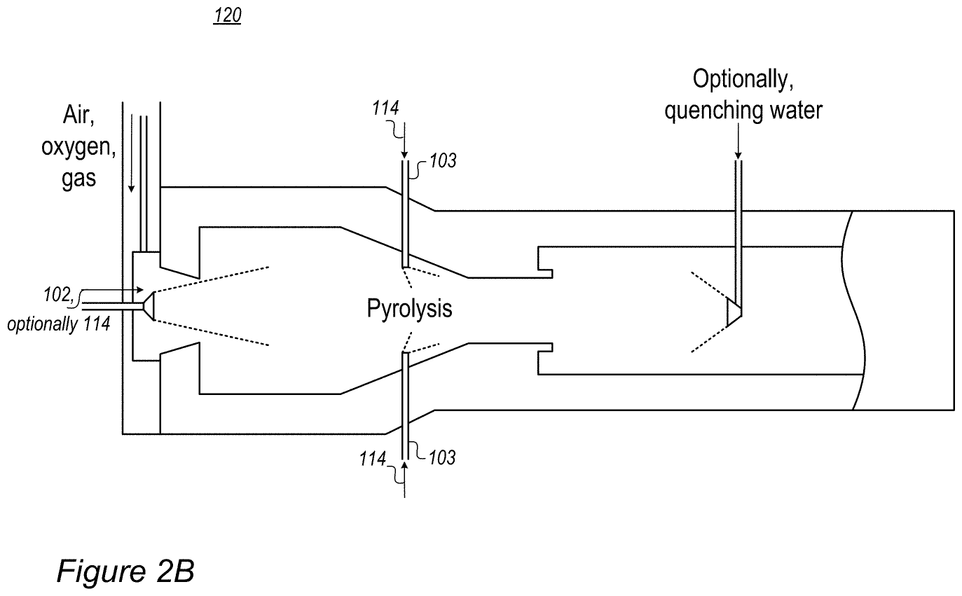

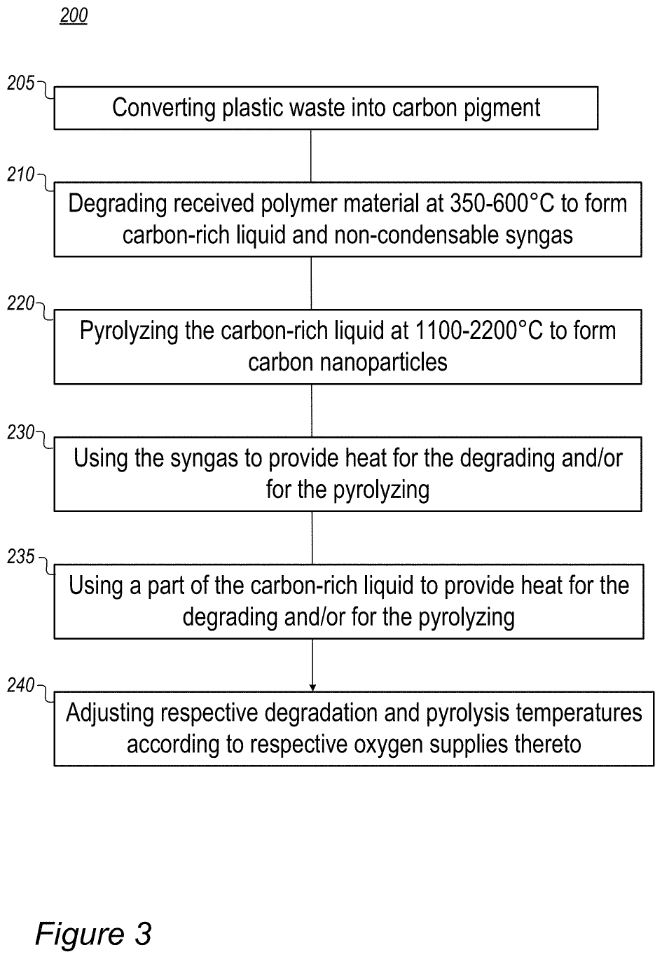

FIGS. 1-3 are high-level schematic illustrations of systems 100 and methods 200 of converting plastic waste into carbon pigment, according to some embodiments of the invention. FIG. 1 illustrates schematically units and material flows in system 100, FIGS. 2A and 2B illustrate schematically structural embodiments of pyrolysis chamber(s) 120 in system 100, and FIG. 3 illustrates schematically stage of method 200, according to some embodiments of the invention. The method stages may be carried out with respect to system 100 described above, which may optionally be configured to implement method 200.

Various embodiments of system 100 are configured for converting plastic waste 90 into carbon pigment, utilizing one or more degradation chamber(s) 110 configured to degrade received polymer material 90 at 350-600° C. to form carbon-rich liquid 114 and non-condensable syngas 112, and one or more pyrolysis chamber(s) 120 configured to pyrolyze at least part of carbon-rich liquid 114 received through inlet(s) 103 from degradation chamber(s) 110 at 1100-2200° C. to form carbon nanoparticles. The formed carbon-rich liquid 114 and non-condensable syngas 112 may be cooled, condensed and separated in cooling unit(s) 115. The formed carbon nanoparticles may be collected as carbon black pigment in collection unit(s) 125.

In various embodiments, the pyrolysis temperature pyrolysis chamber(s) 120 may be between 1200-1500° C., 1500-1800° C. or any other sub-ranges of 1100-2200° C. Typically industrial processes reach the higher part of the temperature range, while small-scale furnaces reach the lower part of the temperature range.

In certain embodiments, the pyrolysis in pyrolysis chamber(s) 120 may be carried out by spray pyrolysis, by atomizing carbon-rich liquid 114 and spraying the atomized carbon-rich liquid 114 in a pre-heated chamber (furnace) to form the carbon nanoparticles.

In certain embodiments, carbon-rich liquid 114 may be derived from additional or other sources, such as combustion of waste tires, petroleum coke or other carbon residues, as non-limiting examples.

Various types of heating materials may be used to provide heat to system 100, for example, natural and/or acetylene gas 102 may be used to provide initial heating of chambers 110 and/or 120, additional heat may be provided by utilizing syngas 112 and/or by utilizing a part of carbon-rich liquid 114, e.g., if excessive amounts of carbon-rich liquid 114 are produced beyond the requirements for carbon pigment production.

FIGS. 2A and 2B provide illustrative non-limiting examples of pyrolysis chamber(s) 120 with respective introduction of carbon-rich liquid 114 that is pyrolyzed therein, natural and/or acetylene gas 102, air, oxygen or other gases, as well as optionally quenching fluid such as water.

In certain embodiments, degradation chamber(s) 110 may be configured to provide indirect contact of a first heat source with the polymer material, and pyrolysis chamber(s) 120 may be configured to provide direct contact of a second heat source with the carbon-rich liquid. The degradation temperature and the pyrolysis temperature may be adjusted according to oxygen supplies to the respective chambers.

System 100 may further comprise unit(s) 130 for environmental protection and treatment (e.g., filtering) of exhaust gases, configured, e.g., to yield zero emissions and/or to be under the limit of environmental protection regulations.

Method 200 may comprise the following stages, irrespective of their order. Methods 200 comprise converting plastic waste into carbon pigment (stage 205), comprising degrading received polymer material at 350-600° C. to form carbon-rich liquid and non-condensable syngas (stage 210), and pyrolyzing the carbon-rich liquid at 1100-2200° C. to form carbon nanoparticles (stage 220). Method 200 may comprise using various types of heating materials, e.g., using the syngas to provide heat for degrading 210 and/or for pyrolyzing 220 (stage 230), using a part of the carbon-rich liquid to provide for degrading 210 and/or for pyrolyzing 220 (stage 235) and/or at least initiating degradation 210 using natural and/or acetylene gas.

In various embodiments, degrading 210 may be carried out under indirect contact of a first heat source with the polymer material, and pyrolyzing 220 may be carried out under direct contact of a second heat source with the carbon-rich liquid. In certain embodiments, pyrolyzing 220 may be carried out by spray pyrolysis—spraying atomized carbon-rich liquid in a pre-heated chamber (furnace) to form the carbon nanoparticles.

Method 200 may further comprise adjusting respective degradation and pyrolysis temperatures according to respective oxygen supplies thereto (stage 240).

Disclosed processes may be implemented as continuous processes, with continuous feeding of plastic waste 90 and conversion thereof into liquid fuel 114 that is used as a source for continuous carbon pigment production.

Elements from FIGS. 1-3 may be combined in any operable combination, and the illustration of certain elements in certain figures and not in others merely serves an explanatory purpose and is non-limiting.

It is noted that the disclosed values understood to encompass ±10% of the respective values.

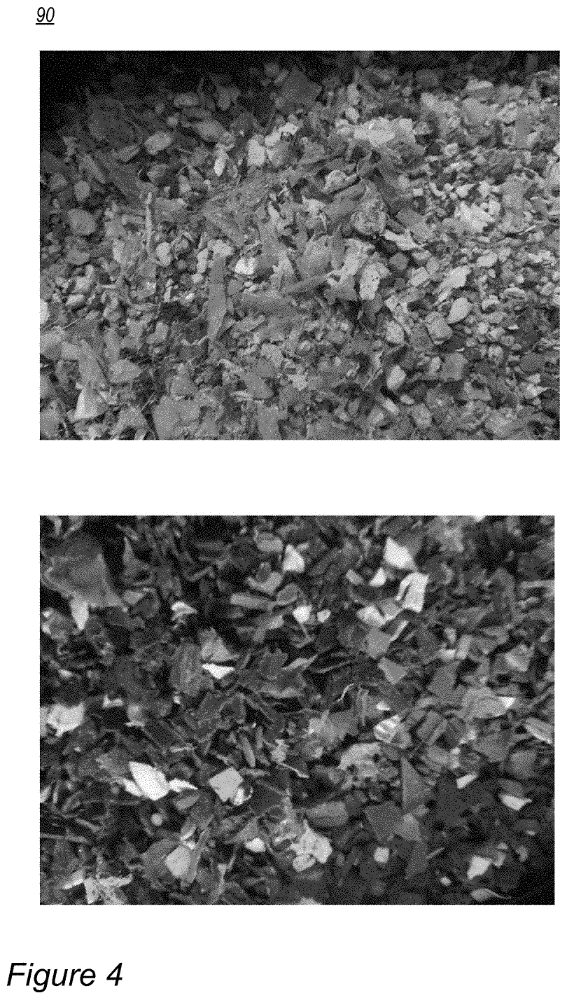

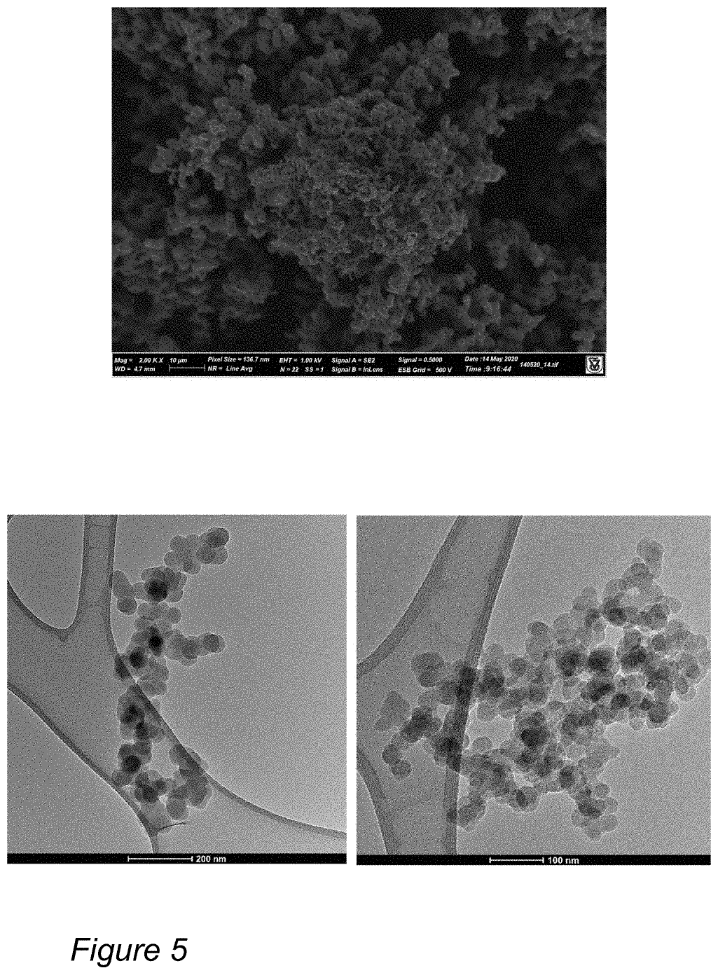

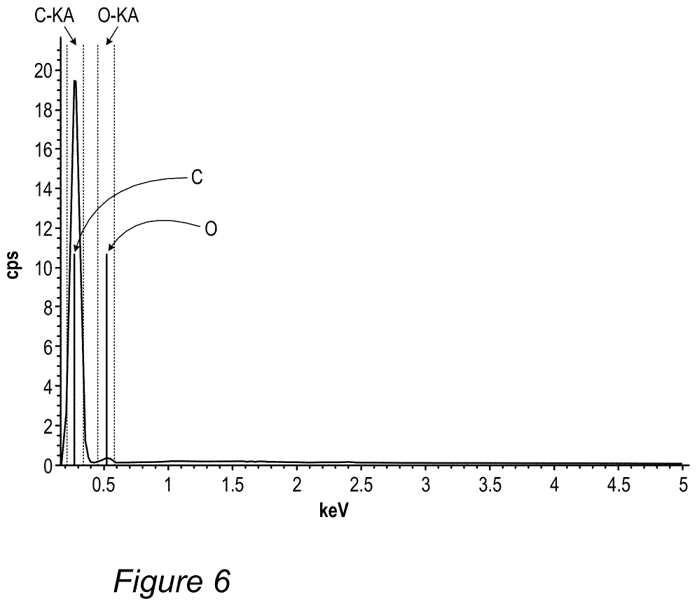

FIG. 4 illustrates schematically white and black plastic waste 90 used as raw material, according to some embodiments of the invention. FIG. 5 illustrates schematically HRSEM (high-resolution scanning electron microscopy) and HRTEM (high-resolution transmission electron microscopy) images of carbon black nanoparticles produced from plastic waste, according to some embodiments of the invention. FIG. 6 illustrates schematically an EDX (energy-dispersive X-ray spectroscopy) diagram of the carbon black nanoparticles produces from the plastic waste, having 98% elemental carbon content, according to some embodiments of the invention.

FIGS. 4-6 illustrate the input material and resulting carbon pigment produced by a small scale prototype implementation of system 100 and method 200, yielding carbon pigment from 1 kg of plastic waste, produced as disclosed above at temperatures of 350° C. and 1100° C. for the first and second stages, respectively.

In a non-limiting experimental example, pyrolysis chamber(s) 120 was operated within the temperature range of 1100−2200° C. at a flow rate of carbon-rich liquid 114 at inlet 102 of between 0.08-2 gr/min and under pressure of between 3-15 bar, with an excess air proportion of 5-30% at flow rates between 0.5-3 m³/min, and with a feeding rate of carbon-rich liquid 114 at inlet(s) 103 of between 0.001-0.010 kg/sec (60-600 gr/min) The resulting carbon nanoparticles (see, for example, FIG. 5) were 20-50 nm in diameter and formed particle aggregate sizes of 2-5 μm that provide electric conductivity by electrical percolation (see, e.g., Choi et al. 2019, Electrical percolation threshold of carbon black in a polymer matrix and its application to antistatic fibre, Sci Rep 9, 6338). It was further noted that the crystallinity of the particles increased as pyrolysis temperatures rose above 1300° C. and higher.

Advantageously, disclosed systems 100 and methods 200 utilize plastic waste to produce carbon pigment that has a wide range of uses in the plastic industry and otherwise. Specifically, plastic waste which cannot be recycled may be used as described herein to provide carbon pigment, possible back to the plastics industry instead of being disposed of. The carbon material product derived from the plastic waste may be used in various applications in the plastic industry, as well as for such as battery materials, conductive inks, smart composite materials, in electronic devices and filter industry.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method of converting plastic waste into carbon pigment, the method comprising:
degrading received polymer material at 350-600° C. to form carbon-rich liquid and non-condensable syngas, and
pyrolyzing the carbon-rich liquid at 1100-2200° C. to form carbon nanoparticles.

2. The method of claim 1, further comprising using the syngas to provide heat for the degrading and/or for the pyrolyzing.

3. The method of claim 1, further comprising using a part of the carbon-rich liquid to provide heat for the degrading and/or for the pyrolyzing.

4. The method of claim 1, wherein the degrading is carried out under indirect contact of a first heat source with the polymer material, and the pyrolyzing is carried out under direct contact of a second heat source with the carbon-rich liquid.

5. The method of claim 1, wherein the pyrolyzing is carried out by spray pyrolysis.

6. The method of claim 1, further comprising adjusting respective degradation and pyrolysis temperatures according to respective oxygen supplies thereto.

7. The method of claim 1, further comprising initiating the degradation using natural and/or acetylene gas.

8. A system for converting plastic waste into carbon pigment, the system comprising:
a degradation chamber configured to degrade received polymer material at 350-600° C. to form carbon-rich liquid and non-condensable syngas, and
a pyrolysis chamber configured to pyrolyze at least part of the carbon-rich liquid received from the degradation chamber at 1100-2200° C. to form carbon nanoparticles.

9. The system of claim 8, wherein at least one of the degradation chamber and the pyrolysis chamber is further configured to be heated using the syngas from the degradation chamber.

10. The system of claim 8, wherein at least one of the degradation chamber and the pyrolysis chamber is further configured to be heated using a part of the carbon-rich liquid from the degradation chamber.

11. The system of claim 8, wherein the degradation chamber is configured to provide indirect contact of a first heat source with the polymer material, and the pyrolysis chamber is configured to provide direct contact of a second heat source with the carbon-rich liquid.

12. The system of claim 8, wherein respective degradation and pyrolysis temperatures are adjusted according to oxygen supplies to the respective chambers.

13. The system of claim 8, wherein the degradation chamber is configured to be initially heated using natural and/or acetylene gas.

14. The system of claim 8, wherein the pyrolysis in the pyrolysis chamber is carried out by spray pyrolysis, atomizing the carbon-rich liquid and spraying the atomized carbon-rich liquid in the pre-heated chamber to form the carbon nanoparticles.
